(19) United States
(12) Patent Application Publication
(10) Pub. No.: US 2025/0242606 A1
(43) Pub. Date: Jul. 31, 2025

(54) LIQUID DISCHARGE APPARATUS AND LIQUID DISCHARGE METHOD

(71) Applicants: Daiki MARUMO, Kanagawa (JP); Masanori HIRANO, Kanagawa (JP); Nanami TAKANO, Tokyo (JP); Yuuta AOKI, Kanagawa (JP); Yuka MIYABE, Kanagawa (JP)

(72) Inventors: Daiki MARUMO, Kanagawa (JP); Masanori HIRANO, Kanagawa (JP); Nanami TAKANO, Tokyo (JP); Yuuta AOKI, Kanagawa (JP); Yuka MIYABE, Kanagawa (JP)

(21) Appl. No.: 19/021,229

(22) Filed: Jan. 15, 2025

(30) Foreign Application Priority Data
Jan. 30, 2024 (JP) 2024-012088

(51) Int. Cl. B41J 11/00; B41J 2/005; B41J 2/01; B41J 3/407; B41J 29/393

(52) U.S. Cl. CPC B41J 11/0015; B41J 2/0057; B41J 3/4078; B41J 29/393; B41J 2002/012; B41J 2029/3935

(57) ABSTRACT

A liquid discharge apparatus is provided that includes a liquid discharger that discharges a liquid onto a transfer base material, an imager, a heater that applies energy to the transfer base material onto which the liquid is discharged to heat the transfer base material, and circuitry. The liquid discharger forms a test patch, with ink as the liquid, on the transfer base material separately from a portion where an image is formed, the imager captures an image of the test patch, and the circuitry is configured to determine an amount of ink bleeding in the transfer base material based on the image captured by the imager, and controls the heater to perform heating based on the amount of ink bleeding.

### CROSS-REFERENCE TO RELATED APPLICATIONS

This patent application is based on and claims priority pursuant to 35 U.S.C. § 119 (a) to Japanese Patent Application No. 2024-012088, filed on Jan. 30, 2024, in the Japan Patent Office, the entire disclosure of which is hereby incorporated by reference herein.

### BACKGROUND

### Technical Field

The present disclosure relates to a liquid discharge apparatus and a liquid discharge method.

### Related Art

A Direct To Film (DTF) type printer has been proposed as an example of a liquid discharge apparatus.

DTF type printers apply coloring ink to a transfer base material such as a film, and heat the coloring ink to form an image to be transferred. For example, a heat-soluble adhesive powder is applied to the image to be transferred, and the coloring ink on the film is transferred to a recording medium such as a clothing item.

### SUMMARY

A liquid discharge apparatus of the present embodiment includes a liquid discharger that discharges a liquid onto a transfer base material, an imager, a heater that applies energy to the transfer base material onto which the liquid is discharged to heat the transfer base material, and circuitry. The liquid discharger forms a test patch, with ink as the liquid, on the transfer base material separately from a portion where an image is formed, the imager captures an image of the test patch, and the circuitry is configured to determine an amount of ink bleeding in the transfer base material based on the image captured by the imager, and controls the heater to perform heating based on the amount of ink bleeding.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus;

FIG. 2 is a diagram illustrating a configuration of a liquid discharge apparatus;

FIG. 3 is a block diagram illustrating a hardware configuration of a liquid discharge apparatus;

FIG. 4 is a diagram illustrating a configuration of a heater in a liquid discharge apparatus;

FIG. 5 is a schematic diagram illustrating an arrangement of a liquid discharger and a sensor;

FIGS. 6A to 6D are schematic cross-sectional views of dots on a transfer base material;

FIGS. 7A and 7B are schematic cross-sectional views of dots on a transfer base material;

FIG. 8 is a schematic plan view of a test patch;

FIGS. 9A to 9C are schematic plan views for describing an interference between inks in a test patch;

FIG. 10 is a flowchart;

FIG. 11 is a flowchart;

FIG. 12 is a graph illustrating a correlation between a temperature of a heater and an ink reception capacity; and

FIG. 13 is a schematic diagram illustrating an arrangement of a liquid discharger and a sensor.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a liquid discharge apparatus is provided that reduces variations in the image quality caused by variations in the quality of a transfer base material, in image formation using a DTF method.

A liquid discharge apparatus and a liquid discharge method according to embodiments of the present invention are described below with reference to the drawings. Note that the present invention is not limited to the embodiments described below, and may be changed within the scope conceivable by a person skilled in the art, including other embodiments, additions, modifications, omissions, and the like. The obtained embodiments are included within the scope of the present invention, as long as the functions and effects of the present invention are achieved in any aspect.

### First Embodiment

A liquid discharge apparatus of the present embodiment includes a liquid discharger that discharges a liquid onto a transfer base material, an imager, a heater that applied energy to the transfer base material onto which the liquid is discharged to heat the transfer base material, and circuitry. The liquid discharger forms a test patch, with ink as the liquid, on the transfer base material separately from a portion where an image is formed. The imager captures an image of the test patch. The circuitry is configured to determine an amount of ink bleeding in the transfer base material based on the image captured by the imager, and control the heater to perform heating based on the amount of ink bleeding.

A liquid discharge method of the present embodiment includes discharging a liquid onto a transfer base material to form a test patch with ink, as the liquid, on the transfer base material separately from a portion where an image is formed, capturing an image of the test patch, determining an amount of ink bleeding in the transfer base material based on the image captured in the capturing, and applying energy to the transfer base material onto which the liquid is discharged to heat the transfer base material based on the amount of ink bleeding.

According to the present embodiment, in image formation by a DTF method, variations in the image quality caused by the transfer base material can be reduced. An image formation process suitable for the transfer base material, and in particular, a heating process suitable for the transfer base material, can be performed. Thus, images of good quality are formed stably.

The test patch is preferably created at multiple locations. In this case, the effect of reducing the variations in the image quality caused by variations in the quality of the transfer base material is enhanced.

Even if transfer base materials are of the same type, transfer base materials vary in quality, and within a single transfer base material, there may be differences in dot formation depending on the location. For example, the thickness of a receiving layer applied to a film, which is an example of a transfer base material, may vary depending on the location, and this may result in differences in the pinning (the shape of a liquid such as ink discharged onto a transfer base material becomes fixed and solidifies) of a liquid (for example, ink) depending on the location. For example, if the film is stored in a humid environment, the receiving layer absorbs moisture, which leads to differences in dot formation.

On the other hand, in the present embodiment, a test patch is formed and an image of the test patch is captured, to determine the amount of ink bleeding and control a heater in accordance with the determined amount of ink bleeding. Thus, it is possible to stably form images of high quality, regardless of the quality of the transfer base material.

Further, in the present embodiment, the reflectance of the transfer base material is measured to determine the thickness of the receiving layer, and the heater is controlled in accordance with the determined thickness of the receiving layer. Thus, it is possible to stably form images of high quality, regardless of the quality of the transfer base material.

In addition, in the present embodiment, a test patch is formed, the density of the test patch is measured, and the thickness of the receiving layer is determined, to control the heater in accordance with the determined thickness of the receiving layer. Thus, it is possible to stably form images of high quality, regardless of the quality of the transfer base material.

The liquid discharge apparatus of the present embodiment can be used as an image forming apparatus, a recording apparatus, a printing apparatus, an inkjet recording apparatus, a DTF printer, and the like.

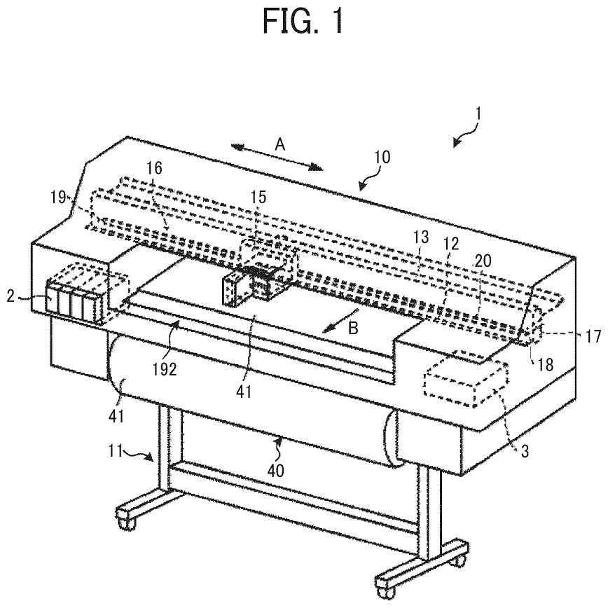

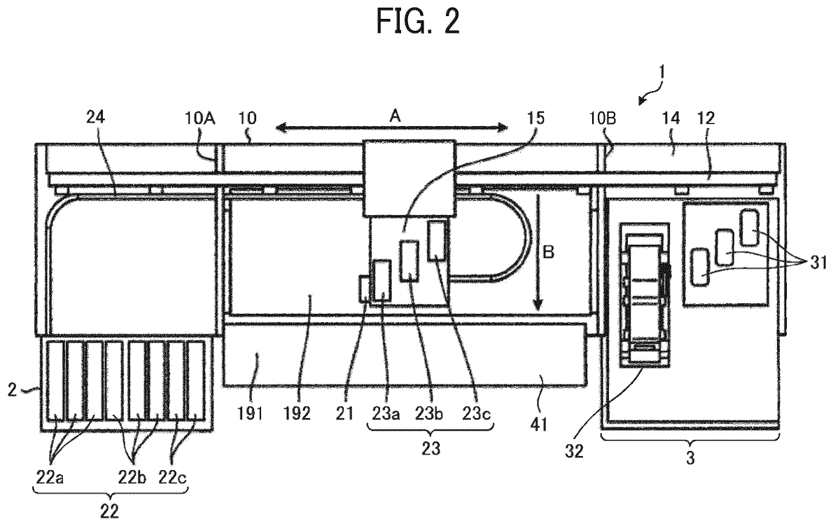

FIG. 1 is a perspective view of a liquid discharge apparatus 1 according to the present embodiment. FIG. 2 is a diagram illustrating a configuration of the liquid discharge apparatus 1 according to the present embodiment. As illustrated in FIGS. 1 and 2, the liquid discharge apparatus 1 according to the present embodiment includes an apparatus main body 10 and a support base 11 supporting the apparatus main body 10.

The apparatus main body 10 includes side plates 10A and 10B on the left and right sides. A guide rod 12 and a guide stay 13, which are guide members, extend between the side plates 10A and 10B. The liquid discharge apparatus 1 further includes a sub-metal guide 14. The guide rod 12 and the guide stay 13 hold a carriage 15 so to be freely slidable.

A main scanning mechanism 16 moves the carriage 15 to perform scanning. The main scanning mechanism 16 includes a main scanning motor 17 arranged on one side of a main scanning direction, a drive pulley 18 that is rotatably driven by the main scanning motor 17, a driven pulley 19 arranged on the other side of the main scanning direction, and a timing belt 20, which is a pulling member that stretches around the drive pulley 18 and the driven pulley 19. The driven pulley 19 is tensioned outward (in a direction away from the drive pulley 18) by a tension spring.

The carriage 15 moves in a direction of an arrow A (main scanning direction) via the timing belt 20 which is rotatably driven by the main scanning motor 17. The carriage 15 includes an optical sensor 21 that detects an end portion of a medium (end portion of a sheet).

The carriage 15 includes a liquid discharge head 23 that discharges ink droplets of various colors, such as black (K), yellow (Y), magenta (M), and cyan (C), in accordance with an ink cartridge 22 mounted in the carriage 15.

The liquid discharge head 23 of the present embodiment is an example of a liquid discharger, and includes, for example, heads 23a, 23b, and 23c. In a part of the description that does not differentiate between the heads 23a, 23b, and 23c, the heads 23a, 23b, and 23c may be referred to as liquid discharge heads 23. The liquid discharge heads 23 include a nozzle array, and the nozzle array is arranged in a direction of an arrow B (sub-scanning direction). Here, the sub-scanning direction is a direction perpendicular to the main scanning direction. The heads 23 are mounted so that a droplet discharge direction is directed downward.

For example, the liquid discharge heads 23 are grounded and shifted from one another in the sub-scanning direction. The carriage 15 includes sub-tanks for supplying ink of each color to the liquid discharge heads 23. In addition, white ink, clear ink, and the like may also be supplied.

The liquid discharge apparatus 1 includes a cartridge loader 2 to which ink cartridges 22a, 22b, 22c, and 22d of each color are attachably and detachably mounted. The ink in the ink cartridges 22 is replenished and supplied to the sub-tanks of the carriage 15 by a supply pump unit via supply tubes 24 for each color. The ink cartridges 22 may include a white ink cartridge or the like.

The liquid discharge apparatus 1 includes a maintenance and recovery mechanism 3 in a non-printing area on one side of the carriage 15 in the main scanning direction. The maintenance and recovery mechanism 3 maintains and recovers the state of the liquid discharge heads 23.

The maintenance and recovery mechanism 3 includes caps 31 for capping each nozzle surface of the liquid discharge heads 23, and a wiping unit 32 for wiping the nozzle surfaces. Further, below the maintenance and recovery mechanism 3, a replaceable waste liquid tank is provided for storing a waste liquid generated by a maintenance and recovery operation.

A sheet 41 is set in a sheet feeder 40, but sheets 41 having different sizes in a width direction can also be set. A transfer base material may be used as the sheet.

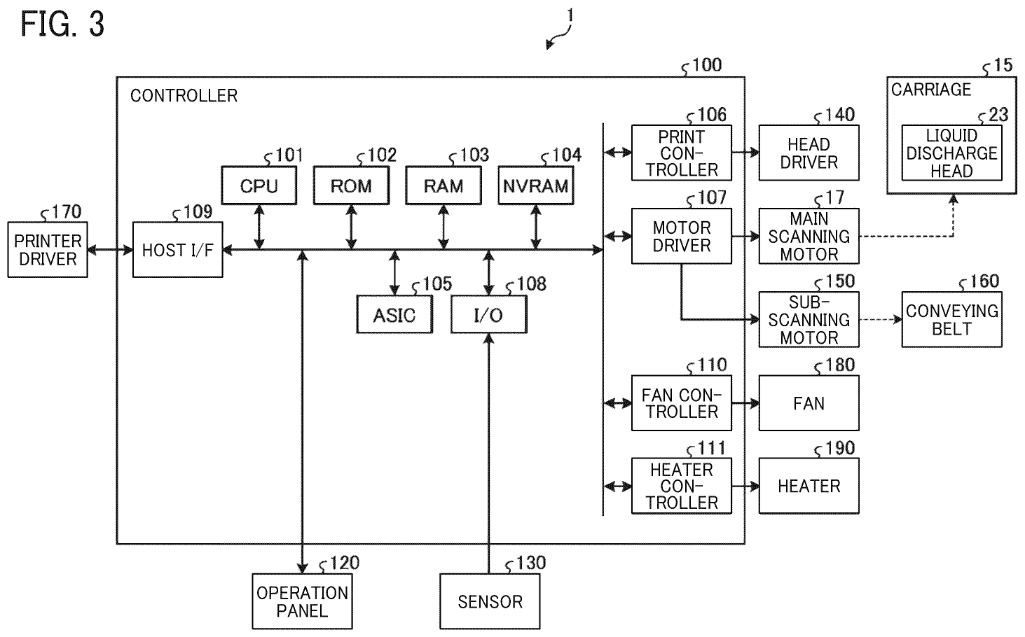

FIG. 3 is a block diagram illustrating the hardware configuration of the liquid discharge apparatus 1 according to the present embodiment. As illustrated in FIG. 3, the liquid discharge apparatus 1 includes a controller 100 as circuitry, an operation panel 120, a sensor 130, a head driver 140, the main scanning motor 17, a sub-scanning motor 150, the carriage 15, a conveying roller 160, a printer driver 170, a fan 180, and a heater 190.

The controller 100 includes a central processing unit (CPU) 101, a read only memory (ROM) 102, and a random access memory (RAM) 103.

The CPU 101 comprehensively controls the liquid discharge apparatus 1. The ROM 102 stores fixed data such as a program to be executed by the CPU 101. The RAM 103 temporarily stores image data and the like.

The controller 100 includes a non-volatile RAM (NVRAM) 104 and an application specific integrated circuit (ASIC) 105.

The NVRAM 104 is a non-volatile memory that retains data, even at a time when the power supply to the liquid discharge apparatus 1 is cut off. The ASIC 105 performs various types of signal processes on the image data and image processes such as sorting, and further, processes input/output signals for comprehensively controlling the liquid discharge apparatus 1.

The controller 100 includes a print controller 106. The carriage 15 transfers data for driving the liquid discharge heads 23 to the head driver 140. The head driver 140 drives the liquid discharge heads 23 provided in the carriage 15 to discharge ink from each of the liquid discharge head 23.

The controller 100 includes a motor driver 107. The motor driver 107 drives the main scanning motor 17 and the sub-scanning motor 150. The main scanning motor 17 drives the carriage 15 to cause the carriage 15 to move and perform scanning. The sub-scanning motor 150 drives the conveying roller 160 to cause the conveying roller 160 to move circularly.

The controller 100 includes an I/O 108. The I/O 108 acquires information from the sensor 130 and extracts information utilized for controlling each member of the main body of the liquid discharge apparatus 1. For example, the sensor 130 corresponds to a group of sensors such as a photosensor, a temperature sensor, and an encoder sensor. The operation panel 120 is used to input and output various types of information.

The controller 100 includes a host I/F 109. The host I/F 109 transmits and receives data and signals to and from a host. Specifically, data and signals are transmitted and received via a cable or a network from a host such as an information processing device including a client PC, an image reading device, and an imaging device at a side of the printer driver 170. The CPU 101 reads and analyzes print data in a reception buffer included in the host I/F 109. The ASIC 105 performs image processing, data sorting processing, and the like, and image data is transferred from the print controller 106 to the head driver 140.

The print controller 106 transfers the image data as serial data, and outputs, to the head driver 140, a transfer clock, a latch signal, a control signal, or the like used for transferring the image data. The head driver 140 selectively supplies drive pulses forming a drive waveform provided by the print controller 106, to a pressure generating means of the liquid discharge head 23, based on image data corresponding to one line of the liquid discharge head 23 that is to be serially input. Thus, the liquid discharge head 23 is driven to discharge a liquid.

By selecting a part or all of the pulses forming the drive waveform, and a part or all of waveform elements forming the pulses, it is possible to obtain dots of different sizes, such as large droplets, medium droplets, and small droplets.

The controller 100 includes a fan controller 110 and a heater controller 111. The fan controller 110 controls an output of the fan 180 so that air is blown at a predetermined temperature and volume. The heater controller 111 controls the heater 190 to obtain a set temperature.

When the fan 180 is driven, the fan 180 promotes convection of air inside the liquid discharge apparatus 1, and prevents the temperature from rising excessively due to stagnation of heated air in an upper part of the liquid discharge apparatus 1. The fan 180 is connected to the fan controller 110 of the controller 100.

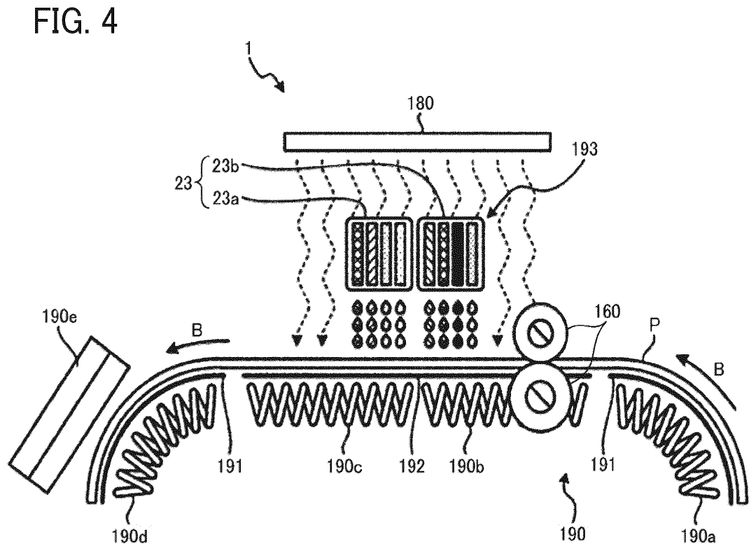

FIG. 4 is a diagram illustrating a configuration of the heater 190 of the liquid discharge apparatus 1 according to the present embodiment. In the example illustrated in FIG. 4, for simplicity, some of the liquid discharge heads 23 are omitted.

As illustrated in FIG. 4, the heater 190 includes a pre-heater 190a, a print heater 190b, a print heater 190c, a post-heater 190d, and a drying heater 190e. Each of these heaters 190 includes a temperature sensor such as a thermistor, to control the temperature.

The pre-heater 190a is a device that preheats a medium P to a temperature suitable for forming a liquid application surface. For example, the pre-heater 190a is an aluminum foil cord heater. The pre-heater 190a is attached to a rear surface of a conveying guide plate 191. The pre-heater 190a heats the medium P by heating the conveying guide plate 191.

The print heater 190b and the print heater 190c heat the medium P when the liquid application surface is formed on the medium P. For example, the print heater 190b and the print heater 190c are cord heaters embedded in a platen 192 made of aluminum. For example, the print heater 190b and the print heater 190c heat the medium P by heating the platen 192.

The post-heater 190d and the drying heater 190e heat the medium P on which the liquid application surface is formed, to dry and fix a liquid such as ink. For example, the post-heater 190d is an aluminum foil cord heater. The post-heater 190d is attached to the rear surface of the conveying guide plate 191. The post-heater 190d heats the medium P by heating the conveying guide plate 191. For example, the drying heater 190e is an IR heater. The drying heater 190e irradiates the liquid application surface of the medium P with IR radiation to dry the liquid application surface. The drying heater 190e may be configured to include a fan and send hot air to the liquid application surface of the medium P.

Next, an example of an operation of the liquid discharge apparatus 1 according to the present embodiment will be described.

The CPU 101 reads and analyzes the print data in the reception buffer of the host I/F 109, uses the ASIC 105 to perform desired image processing, data sorting processing, and the like, and transfers the data to the print controller 106.

The print controller 106 outputs image data and a drive waveform to the head driver 140 at a desired timing. Specifically, the print controller 106 generates a drive waveform including one drive pulse or a plurality of drive pulses by D/A converting and amplifying drive pulse pattern data stored in the ROM 102 and read by the CPU 101.

For example, image data for image output may be generated by storing font data in the ROM 102. Alternatively, the image data may be expanded into a bitmap by a printer driver on the host side and transferred to the liquid discharge apparatus 1.

Based on the input image data, the head driver 140 drives the liquid discharge head 23 by selectively applying, to the pressure generator of the liquid discharge head 23, a drive pulse including a drive waveform provided by the print controller 106.

The heater 190 is turned on when leaving the sleep mode, and is controlled to a set temperature in accordance with the medium P and a mode. When the heater 190 starts operating, the liquid discharge apparatus 1 is in a state where it is possible to form a liquid application surface, and starts an initial operation for forming the liquid application surface. When the formation of the liquid application surface starts, the drying heater 190e starts to turn on.

The medium P is set on a side of the pre-heater 190a. The medium P is conveyed in the direction of the arrow B by the conveying roller 160 to which a drive force is imparted from the sub-scanning motor 150, and a liquid is discharged from the liquid discharge head 23 to form a liquid application surface. For example, as the medium P, in addition to a roll-type transfer base material, it is possible to use PET, PVC, OPP, sheet-like media, and the like, which are referred to as soft packaging media.

The medium P conveyed from the pre-heater 190a is first preheated by the pre-heater 190a to a temperature suitable for forming a liquid application surface. The preheated medium P is conveyed by the conveying roller 160 to an image forming portion 193 in which the liquid discharge head 23 is arranged.

In the image forming portion 193, the medium P is maintained heated by the print heater 190b and the print heater 190c, while a liquid such as ink is discharged onto the medium P from the liquid discharge head 23 to form a liquid application surface. The heated air rises together with the steam. Thus, to prevent the temperature in an upper part of the liquid discharge apparatus 1 from rising excessively due to stagnation of air therein, the fan 180 is used to promote convection of air.

The medium P is conveyed in the sub-scanning direction, and the carriage 15 scans in a direction perpendicular to a movement direction of the medium P, to form an image. When forming the image, the number of scanning operations can be changed in accordance with the resolution of the image to be formed, and thus, it is possible to form an image having high resolution.

The medium P on which the liquid application surface is formed in the image forming portion 193 is conveyed further downstream.

The drying heater 190e performs preheating, so that a filament temperature reaches a target temperature before the medium P on which the liquid application surface is formed arrives at the drying heater 190e. Subsequently, when the medium P on which the liquid application surface is formed arrives, the drying heater 190e is turned on in synchronization with the timing at which the sub-scanning stops.

The timing when the drying heater 190e is turned on can be changed depending on the type and the mode of the medium P.

The post-heater 190d and the drying heater 190e that blows hot air, dry and fix the liquid such as ink on the medium P. After the liquid is dried and fixed on the medium P, the medium P is further wound into a roll downstream.

Next, a detailed example of a liquid discharge apparatus according to a first embodiment will be described.

The liquid discharge apparatus of the present embodiment includes a liquid discharger that discharges a liquid onto a transfer base material, an imager that captures an image of the transfer base material, a heater that heats the transfer base material onto which the liquid is discharged, by applying energy to the transfer base material, and a controller.

An example of the liquid discharger is the head 23. The imager is, for example, the sensor 130. The heater includes, for example, the print heater 190b and the print heater 190c. An example of the controller is the controller 100.

For example, a film may be used as the transfer base material. The film includes, for example, a base material layer and a receiving layer on the base material layer. The film is originally glossy and is altered to have a matte quality by coating the receiving layer. In the film, the thickness of the receiving layer may vary, and this variation in the thickness of the receiving layer may result in differences in the pinning of the ink. Even if the receiving layer is not provided, differences in the pinning of the ink may occur due to variations in the thickness of the transfer base material, and the like.

For example, variations in the quality of the transfer base material include variations in the thickness of the receiving layer that is coated to manufacture the film, and variations in the thickness of the receiving layer result in differences in the pinning of the ink. For example, at a location where the receiving layer is thin, the ink reception capacity is reduced, and thus, the ink overflows, which results in beading and bleeding at color boundaries. Further, if the film is stored in a humid environment, the receiving layer absorbs moisture, and thus, the ink reception capacity decreases and ink overflows. Moreover, differences in the pinning of the ink may occur depending on the type of the receiving layer or the ink, the combination of the film and the ink, the wettability of the film, and the like.

In the present embodiment, the liquid discharger forms a test patch on the transfer base material (the medium P), separately from a portion where the image is formed. The imager captures an image of the test patch. The controller determines the amount of ink bleeding in the transfer base material, based on the imaging result by the imager, and controls heating by the heater, based on the amount of ink bleeding. In the present embodiment, by controlling the heating by the heater based on the amount of ink bleeding, it is possible to prevent variations in the image quality caused by variations in the quality of the transfer base material.

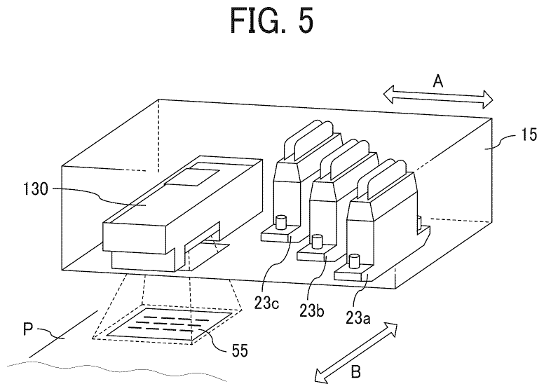

FIG. 5 is a diagram illustrating an example of the imager. The imager in the present example uses the sensor 130. The sensor 130 in the present example captures an image of a test patch 55. The sensor 130 may be a known camera sensor or the like.

A liquid discharge head is used as the liquid discharger. The head 23 is illustrated in the drawings as the liquid discharge head. In the present example, three liquid discharge heads are used, and the heads 23a to 23c are illustrated in FIG. 5. The number of liquid discharge heads and the color types are not particularly limited.

The liquid discharge apparatus of the present example includes the carriage 15 in which a liquid discharger (the heads 23a to 23c) and an imager (the sensor 130) are mounted. In FIG. 5, the arrow A indicates a scanning direction of the carriage 15, and the arrow B indicates a conveyance direction of the transfer base material (the medium P). In the present example, it is possible to improve the device layout by using the carriage 15 in which the liquid discharger and the imager are mounted.

For example, the print heaters 190b and 190c illustrated in FIG. 4 are used as the heaters in the present example. As can be seen from FIGS. 4 and 5, in the present example, the heaters (the print heaters 190b and 190c) are provided at locations facing the carriage 15 across conveyance locations of the transfer base material (the medium P). Thus, a good device layout is obtained, and by controlling the print heaters 190b and 190c, it is easy to adjust the heating temperature for each location on the transfer base material.

As illustrated in FIG. 4, the transfer base material is conveyed on the platen 192, and thus, the conveyance locations of the transfer base material correspond to an area above the platen 192, for example. The print heaters 190b and 190c apply energy (infrared rays in the present example) to the medium P via the platen 192 to heat the medium P.

The head 23 forms the test patch 55 on the medium P, separately from the portion where the image is formed, and the imager captures an image of the test patch 55. The controller 100 acquires an imaging result of the imager. The controller 100 determines the amount of ink bleeding in the transfer base material, based on the imaging result by the imager, and controls heating by the heater, based on the amount of ink bleeding. This makes it possible to form a stable image that is not affected by the state of the transfer base material.

An example of image formation in the present example is described. As illustrated in FIG. 5, the head 23 forms the test patch 55, the imager (the sensor 130) captures an image of the test patch 55, and the controller 100 determines the amount of ink bleeding, based on an imaging result and adjusts the amount of energy of the print heaters 190b and 190c. While the carriage 15 reciprocates in the scanning direction, the head 23 discharges a liquid for forming an image, and the print heaters 190b and 190c heat the transfer base material with an adjusted amount of energy. Thus, it is possible to stably form good images.

The heater may include the pre-heater 190a, the post-heater 190d, and the drying heater 190e. However, in the present embodiment, the heater that is controlled based on the imaging result by the imager preferably includes heaters provided at locations facing the carriage 15 or the head 23, such as the print heaters 190b and 190c, as described above. In this case, there is an advantage that control can be easily performed, based on the imaging result by the imager.

It is preferable that the heater changes the amount of energy applied to each predetermined region of the transfer base material, and the controller determines the amount of ink bleeding for each predetermined region, and adjusts the amount of energy applied by the heater to each predetermined region in accordance with the amount of ink bleeding. In this case, the heating temperature may be changed for each location of the transfer base material. Therefore, it is possible to prevent deterioration of the image and excessive heating, so that the energy consumption decreases.

A method by which the heater changes the amount of energy applied to each predetermined region of the transfer base material can be appropriately selected. For example, a method may be used in which the print heaters 190b and 190c are divided in a scanning direction A and/or a medium conveyance direction B. This makes it possible to adjust the heating temperature for each region of the transfer base material.

The range of the predetermined region is not particularly limited and can be selected appropriately. Further, the number of predetermined regions to be measured is not particularly limited and can be selected appropriately.

The amount of ink bleeding is determined by, for example, a method in which the extent to which dots spread in the imaging result is determined. Another method includes capturing an image of the interference between inks in a test patch and determining the degree of interference between the inks by using image recognition.

The transfer base material in the present embodiment can be appropriately selected and is not particularly limited. A transfer base material for DTF can be preferably used. The present embodiment may be particularly suitably applied to a transfer base material having a receiving layer. An example thereof will be described.

The transfer base material in the present example includes a base material layer and a receiving layer formed on the base material layer and onto which a liquid is discharged. The controller determines an unevenness in the thickness of the receiving layer, based on the imaging result by the imager, and determines the amount of ink bleeding, based on the unevenness in the thickness of the receiving layer. As described above, by determining the unevenness in the thickness of the receiving layer to determine the amount of ink bleeding, it is possible to improve the accuracy in the determination of the amount of ink bleeding.

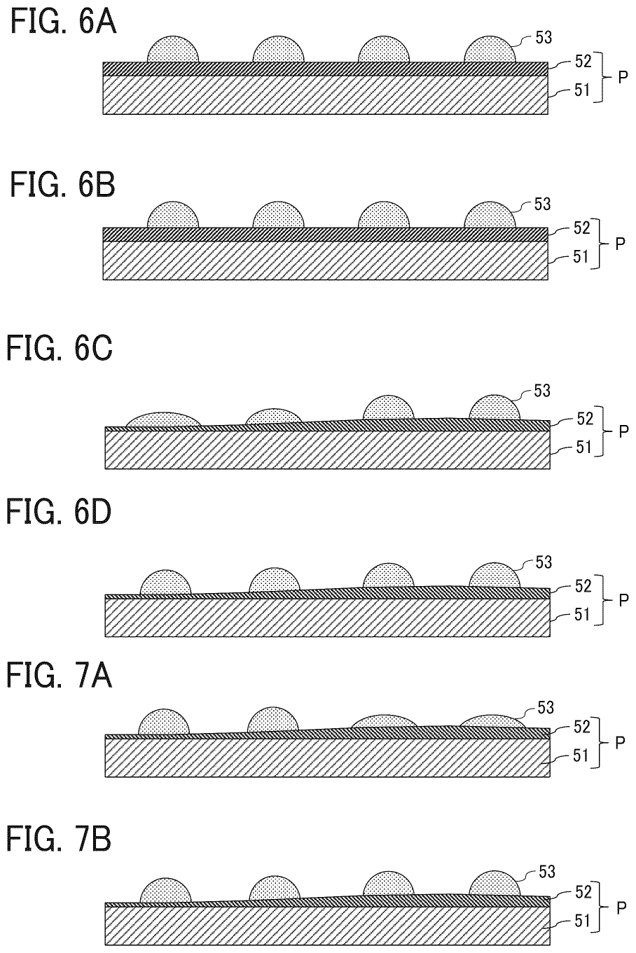

FIGS. 6A to 6D are schematic cross-sectional views of a transfer base material (as an example of the medium P) for explaining its receiving layer. The medium P, which serves as the transfer base material, includes a base material layer 51 and a receiving layer 52. Liquid is discharged onto the receiving layer 52 to form dots 53.

FIG. 6A is a diagram illustrating a state in which the thickness of the receiving layer 52 is uniform and heating is not yet performed. FIG. 6B is a diagram illustrating a state after performing heating in the state illustrated in FIG. 6A. As illustrated in FIGS. 6A and 6B, when the thickness of the receiving layer 52 is uniform, variations are less likely to occur when the dots are formed, and a good image is formed.

FIG. 6C is a diagram illustrating a state in which the thickness of the receiving layer 52 has unevenness. In the example illustrated in FIG. 6C, the dots 53 at a location where the thickness of the receiving layer 52 is large, which are on the right side in the drawing, do not spread in a surface direction. However, the dots 53 at a location where the thickness of the receiving layer 52 is small, which are on the left side in the drawing, spread in the surface direction. The spreading of the dots may be expressed as the fact that the dots have a large area. Whether the dots are spread may be determined by comparing the extent of spreading between dots formed at different positions.

In the present example, the amount of ink bleeding may be determined by observing the extent to which the dots spread in the imaging result. The amount of ink bleeding may be evaluated based on the area of the dots. If the dots spread, the amount of ink bleeding is large, and if the dots do not spread, the amount of ink bleeding is small. For example, when the amount of ink bleeding is large, the amount of energy applied by the heater is increased, and the heating temperature is raised. Thus, it is possible to reduce the spreading of the dots when forming an image portion, and to stably form good images.

FIG. 6D is a diagram illustrating a state in which the amount of energy applied by the heater is adjusted. As illustrated in FIG. 6D, the dots 53 at a location where the thickness of the receiving layer 52 is small, which are on the left side in the drawing, are prevented from spreading in the surface direction. In this case, for example, the amount of energy applied to the dots 53 at a location where the amount of ink bleeding is large, which are on the left side in the drawing, is increased, and the heating temperature is raised.

When the amount of ink bleeding differs depending on the location, the amount of energy applied by the heater is adjusted for each location. When forming an image portion, the medium P is conveyed while the carriage 15 performs scanning, so that the amount of energy applied to each location by the print heaters 190b and 190c is adjusted considering the discharge of liquid from the head 23 in the carriage 15, a conveyance speed of the medium P, and the like.

In the example illustrated in FIG. 6C, the dots 53 at a location where the thickness of the receiving layer 52 is large, which are on the right side in the drawing, do not spread in a surface direction, while the dots 53 at a location where the thickness of the receiving layer 52 is small, which are on the left side in the drawing, spread in the surface direction. However, the present embodiment is not limited thereto. Depending on the combination of the liquid and the transfer base material, this relationship may be reversed. Depending on the combination of the liquid and the transfer base material, dots at a location where the thickness of the receiving layer is large may spread in the surface direction, while dots at a location where the thickness of the receiving layer is small may not spread easily in the surface direction.

Such a case is illustrated in FIGS. 7A and 7B. FIGS. 7A and 7B are schematic cross-sectional views similar to FIGS. 6A to 6D. As illustrated in FIG. 7A, the dots 53 at a location where the thickness of the receiving layer 52 is large, which are on the right side in the drawing, spread in a surface direction. The dots 53 at a location where the thickness of the receiving layer 52 is small, which are on the left side in the drawing, do not spread in the surface direction.

Taking these factors into consideration, it is effective to determine the amount of ink bleeding by capturing an image to determine the extent to which the dots spread in a test patch, regardless of the thickness of the receiving layer.

Next, another example of the method of determining the amount of ink bleeding in the present embodiment will be described.

In the present example, the test patch includes a boundary portion for determining the interference between inks in the test patch. The interference between the inks in the boundary portion is imaged by the imager, and the amount of ink bleeding is determined by the controller.

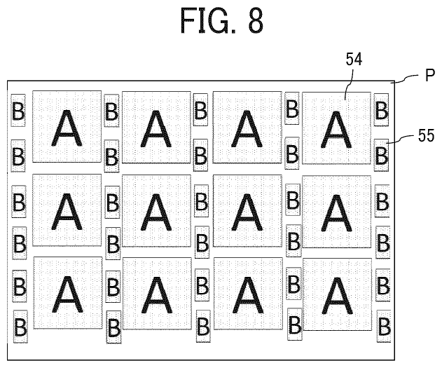

FIG. 8 is a schematic plan view of the medium P for explaining an example of a test patch. In FIG. 8, portions indicated by A are image portions 54 and portions indicated by B are test patches 55. As illustrated in FIG. 8, it is preferable that the test patches 55 are formed at a plurality of locations in the medium P. Thus, the amount of ink bleeding in the medium P may be determined for each location. In the present example, each of the test patches 55 includes a boundary portion. The imager captures an image of an interference between inks at the boundary portion, so that the controller determines the amount of ink bleeding. The amount of ink bleeding may be determined by capturing an image of the boundary portion and determining the degree of encroachment in the boundary portion. An imaging result may be analyzed by using a known image processing technique.

In the example illustrated in FIG. 8, the test patches 55 are formed in a blank portion of the medium P. In DTF applications, images having relatively small size are often repeatedly placed next to each other and printed, and thus, blank spaces are formed on the transfer base material. By forming the test patches 55 in the blank spaces, no waste paper is generated and an unused portion of the transfer base material can be effectively utilized.

In the example illustrated in FIG. 8, the image portions 54 are printed next to each other. In FIG. 8, twelve of the image portions 54 are formed, however, the number is not limited thereto. For example, when one of the image portions 54 is transferred onto one T-shirt, the twelve image portions 54 may be transferred onto twelve T-shirts.

When the test patches 55 are formed in the blank portions of the medium P, it is possible to perform feedback control during printing. For example, while causing the carriage 15 to perform scanning, the following steps are performed, in this order, forming the test patches 55, capturing an image by using the sensor 130, determining the amount of ink bleeding by using the controller 100, discharging liquid (for example, ink) by using the head 23, and heating by using the print heaters 190b and 190c controlled in accordance with the amount of ink bleeding. Thus, it is possible to perform feedback control during printing. Note that the carriage 15 may not always perform scanning at a constant speed, but the speed may be changed as appropriate. For example, the carriage 15 may be temporarily stopped to capture an image.

For example, to form a boundary portion within each of the test patches 55, two or more types of ink of different colors are used to form the test patch 55. The ink being used is not particularly limited. Preferable examples include ink of a color that facilitates observation of interference between inks in the captured image.

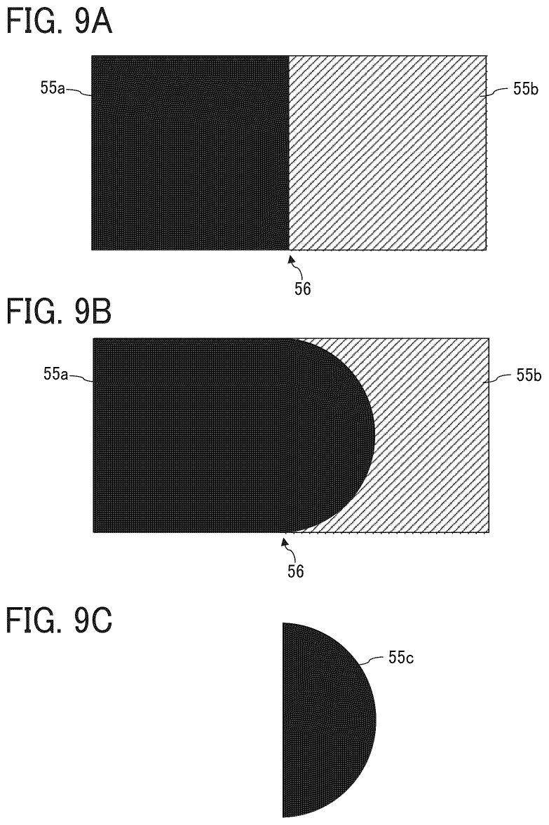

FIGS. 9A to 9C are schematic plan views for explaining an example of interference between inks in a boundary portion of a test patch.

FIG. 9A is a diagram for explaining an example of a boundary portion 56 in the test patch 55. Reference numeral 55a denotes a solid black portion, which indicates a location printed by black ink. The location indicated by reference numeral 55a in the test patch 55 is also referred to as one region 55a. Reference numeral 55b denotes a location printed by an ink other than black ink, for example, cyan ink. The location indicated by reference numeral 55b in the test patch 55 is also referred to as another region 55b. As illustrated in FIG. 9A, the boundary portion 56 is formed by the one region 55a and the other region 55b.

FIG. 9B is a diagram illustrating an example in which inks interfere with each other. Reference numerals 55a and 55b indicate the same contents as in FIG. 9A. As illustrated in FIG. 9B, when inks interfere with each other, overflow occurs at the boundary portion 56. In the example illustrated in FIG. 9B, the one region 55a protrudes from the boundary portion in FIG. 9A and is formed on the side of the other region 55b. By determining the degree of encroachment of the boundary portion 56 by the one region 55a, it is possible to determine the amount of ink bleeding.

FIG. 9C is a diagram illustrating a protruding portion 55c when the one region 55a protrudes from the boundary portion 56 in FIG. 9A, as illustrated in FIG. 9B. The amount of ink bleeding may be determined from the protruding portion 55c.

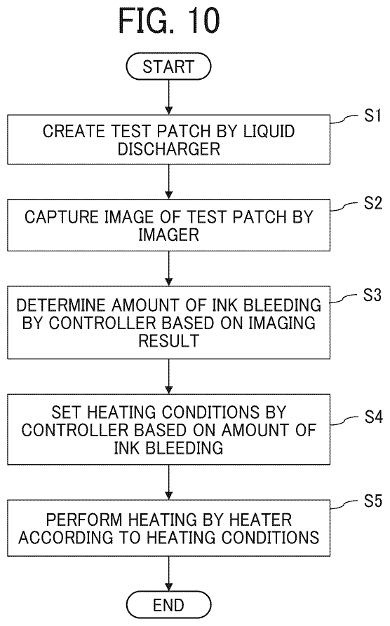

FIG. 10 is an example of a flowchart according to the present embodiment.

In S1, the liquid discharger creates a test patch.

In S2, the imager captures an image of the test patch.

In S3, the controller determines the amount of ink bleeding in the transfer base material, based on an imaging result by the imager.

In S4, the controller sets the heating conditions of the heater, based on the amount of ink bleeding determined by the controller.

The controller controls the heating by the heater according to the heating conditions.

In S5, the heater performs heating in accordance with the heating conditions.

The amount of energy applied by the heater to the transfer medium may be appropriately selected. For example, it is preferable to set a lower limit value of the amount of energy as described below.

In the present example, an upper limit of the amount of ink per unit area of the transfer base material at which ink bleeding does not occur is set to an ink reception capacity 1. Further, the liquid discharge apparatus of the present embodiment includes an information storage that stores a table created in advance and determining the lower limit value of the amount of energy of the heater in accordance with the ink reception capacity 1. Based on the determined amount of ink bleeding, the controller calculates an ink reception capacity 2 to prevent bleeding, replaces the ink reception capacity 1 in the table with the calculated ink reception capacity 2, determines a lower limit value of the amount of energy of the heater, and sets the obtained lower limit value of the amount of energy of the heater to the heater.

An example of a method of using the determined amount of ink bleeding to calculate the ink reception capacity 1 and the ink reception capacity 2 to prevent bleeding, is described below. For example, the amount of ink bleeding is converted into an area, the relationship between the area and the amount of ink adhesion (volume) to prevent bleeding is determined, and the amount of ink adhesion is set as the ink reception capacities 1 and 2.

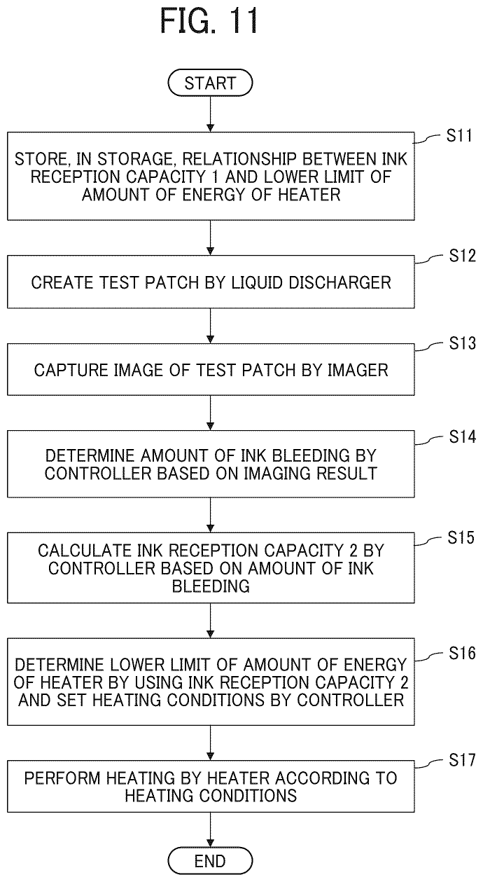

FIG. 11 is a flowchart illustrating another example of the present embodiment.

In S11, the information storage saves (stores) the relationship (the above-described table) between the ink reception capacity 1 and the lower limit value of the amount of energy of the heater corresponding to the ink reception capacity 1. The timing of executing S11 is not particularly limited, as long as S11 is executed before S12. The above-described table is created in advance before executing S12.

In S12, the liquid discharger creates a test patch.

In S13, the imager captures an image of the test patch.

In S14, the controller determines the amount of ink bleeding in the transfer base material, based on an imaging result by the imager.

In S15, the controller calculates the ink reception capacity 2 to prevent bleeding, based on the determined amount of ink bleeding.

In S16, the controller replaces the ink reception capacity 1 in the table with the calculated ink reception capacity 2, determines a lower limit value of the amount of energy of the heater, and sets the heating conditions of the heater to the obtained lower limit value of the amount of energy of the heater. The controller controls the heating by the heater according to the heating conditions.

In S17, the heater performs heating according to the heating conditions.

By setting the amount of energy applied by the heater as described above, it is possible to appropriately perform heating in accordance with the amount of ink bleeding, and to further reduce beading and bleeding at color boundaries caused when ink overflows.

The above-mentioned table is created as follows, for example.

Heating is performed and ink is discharged at a certain temperature, to observe whether ink bleeding occurs when the amount of ink per unit area is increased. The relationship between the amount of ink and the heating temperature when ink bleeding occurs is determined. Thus, it is possible to create the above-mentioned table in advance. The above-mentioned table may be used as a threshold value determination table created for each base material, from the relationship between the bleeding at the boundary between inks and the temperature. The above-mentioned table may be stored in a personal computer or in a printer main body.

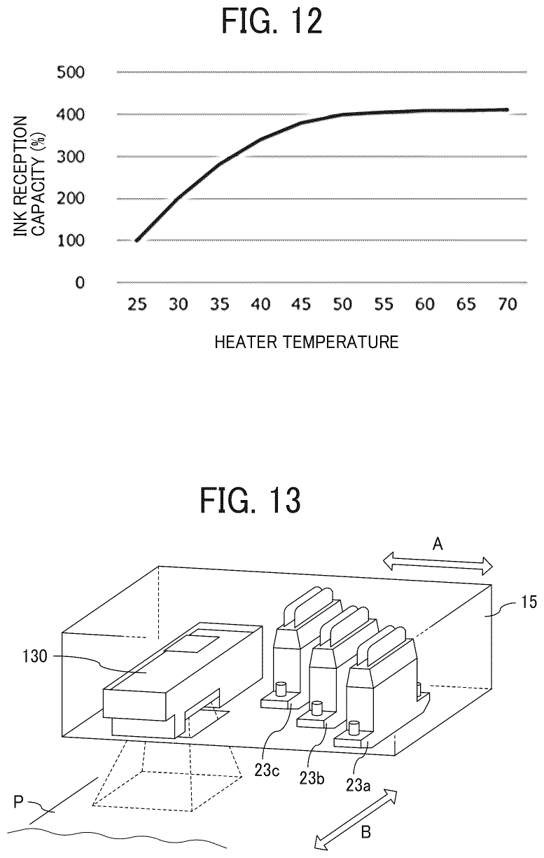

FIG. 12 is a graph for providing a supplementary explanation of the present embodiment, and is a graph illustrating an example of a relationship between a heater temperature and the ink reception capacity. The ink reception capacity described here corresponds to the ink reception capacity 1. The relationship illustrated in FIG. 12 represents the upper limit of the amount of ink at which ink bleeding does not occur. The illustrated example expresses a correlation between the heater temperature and the ink reception capacity in a transfer base material having no receiving layer. A similar correlation is obtained when the transfer base material includes a receiving layer. This means that, regardless of whether the receiving layer is provided, the ink reception capacity increases when heating is performed by a heater, and the ink reception capacity increases when the heater temperature is increased.

For example, when the ink reception capacity is 100% at a heater temperature of 25° C., the ink reception capacity becomes about 400% when the heater temperature is increased to 50° C. In other words, by increasing the heater temperature to 50° C., the ink reception capacity becomes about four times the ink reception capacity at 25° C.

Further, when the temperature increases by a certain level, the ink reception capacity does not increase any more, even if the temperature is further increased. For example, in the example in FIG. 12, at a temperature higher than about 50° C., the ink reception capacity remains at about 400%.

The ink reception capacity is an upper limit of the amount of ink per unit area of the transfer base material at which ink bleeding does not occur. Depending on the type of transfer base material and the type of ink, the ink reception capacity takes different values. Note that, the example of the ink reception capacity described herein is a percentage using % as a unit, but as mentioned in the example above, the ink reception capacity may be defined as an amount.

In the present embodiment, the heater applies energy to the transfer base material. In the above-described example, a heater is used as the heater, and in this case, an example of the energy may be infrared energy. In the present embodiment, the heater is not limited to the heater, and may be an ultraviolet ray irradiation device that emits (may also be referred to as applies) ultraviolet rays as energy. When the heater is an ultraviolet ray irradiation device, a liquid discharged by the liquid discharger is preferably a liquid composition curable with ultraviolet rays.

### Second Embodiment

Next, another embodiment of the present embodiment will be described. Description of content similar to the above-described embodiment will be omitted.

In the present embodiment, the reflectance of the transfer base material is measured. An example of a transfer base material is a film that is originally glossy and is altered to have a matte quality by coating the receiving layer. Different thicknesses of the receiving layer result in different gloss of the transfer base material. Therefore, the thickness of the receiving layer can be determined by measuring the reflectance of the transfer base material. In the present embodiment, the reflectance of the transfer base material is measured to determine the thickness of the receiving layer, and the amount of energy applied by the heater is controlled in accordance with the thickness of the receiving layer. Thus, it is possible to prevent variations in the image quality caused by variations in the film quality.

In the present embodiment, the transfer base material may not have a receiving layer. In the present embodiment, whether the transfer base material includes a receiving layer is determined based on the reflectance measured by a reflectance measurer, and heating by the heater is controlled based on a determination result of whether the transfer base material includes a receiving layer. Thus, it is possible to prevent variations in the image quality caused by variations in the film quality.

A liquid discharge apparatus of the present embodiment will be described.

The liquid discharge apparatus of the present embodiment includes a liquid discharger that discharges liquid onto a transfer base material, a reflectance measurer that measures the reflectance of the transfer base material, a heater that heats the transfer base material onto which the liquid is discharged, by applying energy to the transfer base material, and a controller.

The controller determines whether the transfer base material includes a receiving layer, based on the reflectance measured by the reflectance measurer, and controls heating by the heater, based on the determination result of whether the transfer base material includes a receiving layer.

A liquid discharge method of the present embodiment is a liquid discharge method performed by the liquid discharge apparatus of the present embodiment. In a reflectance measuring step, the reflectance of the transfer base material is measured. In a control step, whether the transfer base material includes a receiving layer is determined based on the reflectance measured in the reflectance measuring step, and in a heating step, heating is controlled based on a determination result of whether the transfer base material includes a receiving layer.

The details in the control process may be appropriately selected. For example, if it is determined that no receiving layer is provided, the thickness of the receiving layer is set to 0 to perform control. The details in the control process may also be appropriately selected depending on the combination of the liquid and the transfer base material and the like, and thus, are not limited. However, if it is determined that no receiving layer is provided, stronger heat is applied.

In a preferred aspect of the present embodiment, the transfer base material includes a base material layer and a receiving layer formed on the base material layer and onto which the liquid is discharged. The controller determines the thickness of the receiving layer of the transfer base material, based on the reflectance measured by the reflectance measurer, and controls the heating by the heater, based on the determined thickness of the receiving layer. This makes it possible to further reduce variations in the image quality.

For example, when the measured reflectance is high, it may be determined that the thickness of the receiving layer is large, and when the measured reflectance is low, it may be determined that the thickness of the receiving layer is small. Although the method is not particularly limited, a reference value of the reflectance and the thickness of the receiving layer at the reference value may be determined in advance, and the thickness of the receiving layer may be determined by comparing the measured reflectance with the reference value.

The arrangement of the reflectance measurer may be appropriately selected.

FIG. 13 is a diagram illustrating an example in which the sensor 130 is used as the reflectance measurer. The reflectance measurer (the sensor 130) may be mounted in the carriage 15 together with the head 23. In this case, it is possible to improve the device layout.

As described by using FIGS. 4 and 13, the liquid discharge apparatus of the present embodiment includes the carriage 15 in which a liquid discharger (the head 23) and a reflectance measurer (the sensor 130) are mounted. It is preferable that a heater is provided at a location facing the carriage 15 across a conveyance location of the transfer base material. In this case, the measurement results from the reflectance measurer may be used to perform feedback control to control the heater, and the device layout may be improved.

The arrangement of the reflectance measurer is not limited to the example illustrated in FIG. 13 and may be changed as appropriate. For example, the reflectance measurer may not be mounted in the carriage 15, but may be arranged upstream from the liquid discharger. For example, in the example illustrated in FIG. 4, the reflectance measurer may be arranged upstream from the conveying roller 160. For example, the reflectance measurer may be arranged at a position facing the pre-heater 190a.

The sensor 130 may include a plurality of sensors 130. For example, both the reflectance measurer and the imager may be provided as the sensor 130. The determination whether the transfer base material includes a receiving layer and the measurement of the thickness of the receiving layer may both be performed by using the reflectance measurer, or by using the imager. Further, whether the transfer base material includes a receiving layer may be determined by performing a measurement using the reflectance measurer, and the thickness of the receiving layer may be measured by using the imager.

In the present embodiment, it is also preferable that the heater can adjust the heating temperature for each predetermined region. This example is again described below.

It is preferable that the heater can change the amount of energy for each predetermined region of the transfer base material, and that the controller determines the thickness of the receiving layer for each predetermined region and adjusts the amount of energy of the heater for each predetermined region in accordance with the thickness of the receiving layer.

In this case, the heating temperature can be changed for each location of the transfer base material. Therefore, it is possible to prevent deterioration of the image and excessive heating, so that the energy consumption decreases.

In the present embodiment, it is also preferable that the upper limit of the amount of ink per unit area of the transfer base material at which ink bleeding does not occur is defined as an ink reception capacity 1 and that an information storage is provided that stores a table created in advance and determining the lower limit value of the amount of energy of the heater corresponding to the ink reception capacity 1. It is preferable that the controller calculates, based on the determined amount of ink bleeding, an ink reception capacity 2 to prevent bleeding, replaces the ink reception capacity 1 in the table with the calculated ink reception capacity 2, determines a lower limit value of the amount of energy of the heater, and sets the obtained lower limit value of the amount of energy of the heater to the heater.

A supplementary explanation of the present embodiment will be given below. In the present embodiment, whether the transfer base material includes a receiving layer is determined based on the reflectance measured by the reflectance measurer, and heating by the heater is controlled based on a determination result of whether the transfer base material includes a receiving layer. The details of the control process may be appropriately changed in consideration of the combination of the liquid and the transfer base material and the like. For example, if the receiving layer is not provided or if the receiving layer is thin, the ink reception capacity decreases, the ink is more likely to overflow, and beading and bleeding at color boundaries are more likely to occur. Therefore, the heating temperature is increased in regions where the receiving layer is not provided or where the receiving layer is thin. In addition, for example, in a region where the receiving layer is present and where the receiving layer is thick, the heating temperature is controlled to obtain a minimum temperature.

### Third Embodiment

Next, another embodiment of the present embodiment will be described. Description of content similar to the above-described embodiments will be omitted.

In the present embodiment, a test patch is formed and the density of the test patch is measured. Different thicknesses of the receiving layer result in different density of the test patch. Therefore, the thickness of the receiving layer may be determined by measuring the density of the test patch formed on the transfer base material. The amount of energy applied by the heater is controlled in accordance with the thickness of the receiving layer. Thus, it is possible to prevent variations in the image quality caused by variations in the film quality.

In the present embodiment, the transfer base material may not have a receiving layer. In the present embodiment, whether the transfer base material includes a receiving layer is determined based on a measurement result of a density measurer, and heating by the heater is controlled based on a determination result of whether the transfer base material includes a receiving layer. Thus, it is possible to prevent variations in the image quality caused by variations in the film quality.

The liquid discharge apparatus of the present embodiment will be described.

The liquid discharge apparatus of the present embodiment includes a liquid discharger that discharges a liquid onto a transfer base material, a density measurer that measures a density of the liquid discharged onto the transfer base material, a heater that heats the transfer base material onto which the liquid is discharged, by applying energy to the transfer base material, and a controller.

The liquid discharger forms a test patch on the transfer base material separately from a portion where the image is formed.

The test patch is formed by using ink as the liquid to be discharged.

The density measurer measures a density of the test patch.

The controller determines whether the transfer base material includes a receiving layer, based on a measurement result of the density measurer, and controls heating by the heater, based on a determination result of whether the transfer base material includes a receiving layer.

The liquid discharge method of the present embodiment is a liquid discharge method performed by the liquid discharge apparatus of the present embodiment. In a liquid discharge step, a test patch is formed on the transfer base material separately from a portion where the image is formed. The test patch is formed by using ink as the liquid to be discharged. In a density measuring step, the density of the test patch is measured. In a control step, it is determined whether the transfer base material includes a receiving layer, based on a measurement result of the density measuring step, and heating in the heating step is controlled based on a determination result of whether the transfer base material includes a receiving layer.

The test patch in the present embodiment may be similar to the test patch of the first embodiment described above.

The details in the control process may be appropriately selected. For example, if it is determined that no receiving layer is provided, the thickness of the receiving layer is set to 0 to perform control. The details in the control process may also be appropriately selected depending on the combination of the liquid and the transfer base material and the like, and thus, are not limited. However, if it is determined that no receiving layer is provided, higher heat is applied.

In a preferred aspect of the present embodiment, the transfer base material includes a base material layer and a receiving layer formed on the base material layer and onto which the liquid is discharged. The controller determines the thickness of the receiving layer of the transfer base material, based on a measurement result by the density measurer, and controls the heating by the heater, based on the determined thickness of the receiving layer. This makes it possible to further reduce variations in the image quality.

As described in FIGS. 4 and 13, the liquid discharge apparatus of the present embodiment includes the carriage 15 in which a liquid discharger (the head 23) and a density measurer (the sensor 130) are mounted. It is preferable that a heater is provided at a location facing the carriage 15 across a conveyance location of the transfer base material. In this case, the measurement results from the density measurer can be used to perform feedback control to control the heater, and the device layout can be improved.

In the present embodiment, it is also preferable that the heater can adjust the heating temperature for each predetermined region. This example is again described below.

It is preferable that the heater can change the amount of energy for each predetermined region of the transfer base material, and that the controller determines the thickness of the receiving layer for each predetermined region and adjusts the amount of energy of the heater for each predetermined region in accordance with the thickness of the receiving layer.

In this case, the heating temperature can be changed for each location of the transfer base material. Therefore, it is possible to prevent deterioration of the image and excessive heating, so that the energy consumption decreases.

In the present embodiment, it is also preferable that the upper limit of the amount of ink per unit area of the transfer base material at which ink bleeding does not occur is defined as an ink reception capacity 1 and that an information storage is provided that stores a table created in advance and determining the lower limit value of the amount of energy of the heater corresponding to the ink reception capacity 1. It is preferable that the controller calculates, based on the determined amount of ink bleeding, an ink reception capacity 2 to prevent bleeding, replaces the ink reception capacity 1 in the table with the calculated ink reception capacity 2, determines a lower limit value of the amount of energy of the heater, and sets the obtained lower limit value of the amount of energy of the heater to the heater.

A supplementary explanation of the present embodiment will be given below. In the present embodiment, whether the transfer base material includes a receiving layer is determined based on a measurement result of the density of the test patch measured by the density measurer, and heating by the heater is controlled based on a determination result of whether the transfer base material includes a receiving layer. The details of the control process may be appropriately changed in consideration of the combination of the liquid and the transfer base material and the like. For example, if the receiving layer is not provided or if the receiving layer is thin, the ink reception capacity decreases, the ink is more likely to overflow, and beading and bleeding at color boundaries are more likely to occur. Therefore, the heating temperature is increased in regions where the receiving layer is not provided or where the receiving layer is thin. In addition, for example, in a region where the receiving layer is present and where the receiving layer is thick, the heating temperature is controlled to obtain a minimum temperature.

In the present embodiment, the amount of ink bleeding may be determined by using the measurement result of the density of the test patch measured by the density measurer. For example, when the density of a halftone patch is measured, it is determined whether the density exceeds a certain threshold value. If the density exceeds the threshold value, it is determined that the ink wets and spreads, ink bleeding occurs in the solid gradation, and ink is excessively deposited. In this case, for example, the heating temperature by the heater is increased in the region where the ink is excessively deposited, to prevent the image quality from deteriorating.

### Fourth Embodiment

In the above-described embodiment, an example is described in which the transfer base material may not have a receiving layer.

In the present embodiment, it is assumed that the transfer base material needs to have a receiving layer. Description of content similar to the above-described embodiments will be omitted.

The liquid discharge apparatus of the present embodiment includes a transfer base material having a base material layer and a receiving layer formed on the base material layer and onto which the liquid is discharged, a liquid discharger that discharges a liquid onto the transfer base material, a receiving layer thickness determiner that determines an unevenness in the thickness of the receiving layer, a heater that heats the transfer base material onto which the liquid is discharged, by applying energy to the transfer base material, and a controller. The controller controls the heating by the heater in accordance with the unevenness in the thickness of the receiving layer.

The liquid discharge method of the present embodiment includes a liquid discharge step of discharging a liquid onto a transfer base material having a base material layer and a receiving layer formed on the base material layer and onto which the liquid is discharged, a receiving layer thickness determination step of determining an unevenness in the thickness of the receiving layer, a heating step of heating the transfer base material onto which the liquid is discharged, by applying energy to the transfer base material, and a control step. In the control step, the heating in the heating step is controlled in accordance with the unevenness in the thickness of the receiving layer.

The receiving layer thickness determiner in the present embodiment may use the imager, the reflectance measurer, and the density measurer described in the above-described embodiment. The receiving layer thickness determination step in the present embodiment is executed by the receiving layer thickness determiner. Examples of methods of measuring the thickness of the receiving layer include a method of capturing an image of a test patch, a method of measuring the reflectance of the transfer base material, a method of measuring the density of the transfer base material, and a method of capturing an image of a test patch and measuring the density of the test patch. These methods may use the configurations described in the above-described embodiments.

Similarly to the above-described embodiments, the thickness of the receiving layer is determined, and the heater is controlled in accordance with the unevenness in the thickness of the receiving layer. The thickness of the receiving layer is determined for each predetermined region, and the heating temperature is controlled for each determined region, for example.

Aspects of the present disclosure are, for example, as follows.

According to a first aspect, a liquid discharge apparatus includes
a liquid discharger that discharges a liquid onto a transfer base material,
an imager,
a heater that applies energy to the transfer base material onto which the liquid is discharged to heat the transfer base material, and a controller, in which
the liquid discharger forms a test patch, with ink as the liquid, on the transfer base material separately from a portion where an image is formed,
the imager captures an image of the test patch, and
the controller determines an amount of ink bleeding in the transfer base material based the image captured by the imager, and controls the heater to perform heating based on the amount of ink bleeding.

According to a second aspect, in the liquid discharge apparatus according to the first aspect,
the controller determines an unevenness in a thickness of a receiving layer, onto which the liquid is discharged, of the transfer base material based on the image captured by the imager, and determines the amount of ink bleeding based on the unevenness in the thickness of the receiving layer.

According to a third aspect, a liquid discharge apparatus includes
a transfer base material having a base material layer and a receiving layer on the base material layer and onto which a liquid is discharged,
a liquid discharger that discharges a liquid onto the transfer base material,
a receiving layer thickness determiner that determines an unevenness in a thickness of the receiving layer,
a heater that applies energy to the transfer base material onto which the liquid is discharged to heat the transfer base material, and
a controller that control the heater to perform heating in accordance with the unevenness in the thickness of the receiving layer.

According to a fourth aspect, in the liquid discharge apparatus according to the first or the second aspect,
the heater changes an amount of energy applied to each predetermined region of the transfer base material, and
the controller determines the amount of ink bleeding for the each predetermined region, and adjusts the amount of energy applied by the heater to the each predetermined region in accordance with the amount of ink bleeding.

According to a fifth aspect, in the liquid discharge apparatus according to the first, the second, or the fourth aspect,
the test patch has a boundary portion to determine an interference between inks in the test patch,
the imager captures an image of the interference between inks at the boundary portion, and
the controller determines the amount of ink bleeding based on the image of the interference captured by the imager.

According to a sixth aspect, the liquid discharge apparatus according to any one of the first to the fifth aspects further includes
a carriage carrying the liquid discharger and the imager, in which
the heater is disposed facing the carriage across a conveyance location of the transfer base material.

According to a seventh aspect, the liquid discharge apparatus according to any one of the first to the sixth aspects further includes
an information storage that stores a table for determining a lower limit of an amount of energy of the heater in accordance with an ink reception capacity 1, where the ink reception capacity 1 is an upper limit of an amount of ink per unit area of the transfer base material which does not cause ink bleeding, in which
the controller calculates, based on the determined amount of ink bleeding, an ink reception capacity 2 being an amount of ink which does not cause ink bleeding, replaces the ink reception capacity 1 in the table with the calculated ink reception capacity 2, determines the lower limit of the amount of energy of the heater, and sets the determined lower limit of the amount of energy of the heater to the heater.

According to an eighth aspect, a liquid discharge apparatus includes
a liquid discharger that discharges a liquid onto a transfer base material,
a reflectance measurer that measures a reflectance of the transfer base material,
a heater that applies energy to the transfer base material onto which the liquid is discharged to heat the transfer base material, and
a controller that determines whether the transfer base material includes a receiving layer, based on the reflectance measured by the reflectance measurer, and controls the heater to perform heating based on a determination result of whether the transfer base material includes a receiving layer.

According to a ninth aspect, in the liquid discharge apparatus according to the eighth aspect,
the transfer base material includes a base material layer and a receiving layer formed on the base material layer and onto which the liquid is discharged, and
the controller determines a thickness of the receiving layer of the transfer base material based on the reflectance measured by the reflectance measurer, and controls the heater to perform heating based on the determined thickness of the receiving layer.

According to a tenth aspect, a liquid discharge apparatus includes
a liquid discharger that discharges a liquid onto a transfer base material,
a density measurer that measures a density of the liquid discharged onto the transfer base material,
a heater that applies energy to the transfer base material onto which the liquid is discharged to heat the transfer base material, and
a controller, in which
the liquid discharger forms a test patch, with ink as the liquid, on the transfer base material separately from a portion where an image is formed,
the density measurer measures a density of the test patch, and
the controller determines whether the transfer base material includes a receiving layer based on a measurement result by the density measurer, and controls the heater to perform heating based on a determination result of whether the transfer base material includes a receiving layer.

According to an eleventh aspect, in the liquid discharge apparatus according to the tenth aspect,
the transfer base material includes a base material layer and a receiving layer formed on the base material layer and onto which the liquid is discharged, and
the controller determines a thickness of the receiving layer of the transfer base material based on a measurement result by the density measurer, and controls the heater to perform heating based on the determined thickness of the receiving layer.

According to a twelfth aspect, in the liquid discharge apparatus according to the ninth or the eleventh aspect,
the heater changes an amount of energy applied to each predetermined region of the transfer base material, and
the controller determines the thickness of the receiving layer for the each predetermined region, and adjusts the amount of energy applied by the heater to the each predetermined region in accordance with the thickness of the receiving layer.

According to a thirteenth aspect, the liquid discharge apparatus according to the eighth, the ninth, or the twelfth aspect further includes
a carriage carrying the liquid discharger and the reflectance measurer, and
the heater is disposed facing the carriage across a conveyance location of the transfer base material.

According to a fourteenth aspect, the liquid discharge apparatus according to any one of the tenth, the eleventh, or the twelfth aspect further includes
a carriage carrying the liquid discharger and the density measurer are mounted, and
the heater is disposed facing the carriage across a conveyance location of the transfer base material.

According to a fifteenth aspect, the liquid discharge apparatus according to the ninth or the eleventh aspect further includes
an information storage that stores a table for determining a lower limit of an amount of energy of the heater in accordance with an ink reception capacity 1, where the ink reception capacity 1 is an upper limit of an amount of ink per unit area of the transfer base material which does not cause ink bleeding, in which
the controller calculates, based on the determined thickness of the receiving layer, an ink reception capacity 2 being an amount of ink which does not cause ink bleeding, replaces the ink reception capacity 2 in the table with the calculated ink reception capacity 2, determines the lower limit of the amount of energy of the heater, and sets the determined lower limit of the amount of energy of the heater to the heater.

According to a sixteenth aspect, a liquid discharge method includes
a liquid discharge step of discharging a liquid onto a transfer base material,
an imaging step,
a heating step of heating the transfer base material onto which the liquid is discharged, by applying energy to the transfer base material, and
a control step, in which
the liquid discharge step includes forming a test patch on the transfer base material separately from a portion where an image is formed,
the test patch is formed by using ink as the liquid to be discharged,
the imaging step includes capturing an image of the test patch, and
the control step includes determining an amount of ink bleeding in the transfer base material based on an imaging result in the imaging step, and controlling heating in the heating step based on the amount of ink bleeding.

According to a seventeenth aspect, a liquid discharge method includes
a liquid discharge step of discharging a liquid onto a transfer base material having a base material layer and a receiving layer formed on the base material layer and onto which the liquid is discharged,
a receiving layer thickness determination step of determining an unevenness in a thickness of the receiving layer,
a heating step of heating the transfer base material onto which the liquid is discharged, by applying energy to the transfer base material, and
a control step, in which
the control step includes controlling heating in the heating step in accordance with the unevenness in the thickness of the receiving layer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus, comprising:
a liquid discharger that discharges a liquid onto a transfer base material;
an imager;
a heater that applies energy to the transfer base material onto which the liquid is discharged to heat the transfer base material; and
circuitry, wherein
the liquid discharger forms a test patch, with ink as the liquid, on the transfer base material separately from a portion where an image is formed,
the imager captures an image of the test patch, and
the circuitry is configured to determine an amount of ink bleeding in the transfer base material based on the image captured by the imager, and control the heater to perform heating based on the amount of ink bleeding.

2. The liquid discharge apparatus according to claim 1, wherein
the circuitry is further configured to determine an unevenness in a thickness of a receiving layer, onto which the liquid is discharged, of the transfer base material based on the image captured by the imager, and determine the amount of ink bleeding based on the unevenness in the thickness of the receiving layer.

3. A liquid discharge apparatus, comprising:
a transfer base material including:
a base material layer; and
a receiving layer on the base material layer and onto which a liquid is discharged;
a liquid discharger that discharges a liquid onto the transfer base material;
a receiving layer thickness determiner that determines an unevenness in a thickness of the receiving layer;
a heater that applies energy to the transfer base material onto which the liquid is discharged to heat the transfer base material; and
circuitry configured to control the heater to perform heating in accordance with the unevenness in the thickness of the receiving layer.

4. The liquid discharge apparatus according to claim 1, wherein
the heater changes an amount of energy applied to each predetermined region of the transfer base material, and
the circuitry is further configured to determine the amount of ink bleeding for the each predetermined region, and adjust the amount of energy applied by the heater to the each predetermined region in accordance with the amount of ink bleeding.

5. The liquid discharge apparatus according to claim 1, wherein
the test patch has a boundary portion to determine an interference between inks in the test patch,
the imager captures an image of the interference between inks at the boundary portion, and
the circuitry is further configured to determine the amount of ink bleeding based on the image of the interference captured by the imager.

6. The liquid discharge apparatus according to claim 1, further comprising a carriage carrying the liquid discharger and the imager, wherein
the heater is disposed facing the carriage across a conveyance location of the transfer base material.

7. The liquid discharge apparatus according to claim 1, further comprising an information storage that stores a table for determining a lower limit of an amount of energy of the heater in accordance with an ink reception capacity 1, the ink reception capacity 1 being an upper limit of an amount of ink per unit area of the transfer base material which does not cause ink bleeding, wherein
the circuitry is further configured to calculate, based on the determined amount of ink bleeding, an ink reception capacity 2 being an amount of ink which does not cause ink bleeding, replace the ink reception capacity 1 in the table with the calculated ink reception capacity 2, determine the lower limit of the amount of energy of the heater, and set the determined lower limit of the amount of energy of the heater to the heater.

8. A liquid discharge method, comprising:
discharging a liquid onto a transfer base material to form a test patch with ink, as the liquid, on the transfer base material separately from a portion where an image is formed;
capturing an image of the test patch;
determining an amount of ink bleeding in the transfer base material based on the image captured in the capturing; and
applying energy to the transfer base material onto which the liquid is discharged to heat the transfer base material based on the amount of ink bleeding.
